(19) United States
(12) Patent Application Publication
(10) Pub. No.: US 2020/0208794 A1
(43) Pub. Date: Jul. 2, 2020

(54) Trunk Wrap Lighting Device

(71) Applicant: Kurt STANGE, Miami Beach, FL (US)

(72) Inventor: Kurt STANGE, Miami Beach, FL (US)

(21) Appl. No.: 16/615,663

(22) PCT Filed: May 22, 2018
(86) PCT No.: PCT/US18/33949

§ 371 Date: Nov. 21, 2019

Related U.S. Application Data
(60) Provisional application No. 62/510,089, filed on May 23, 2017.

(51) Int. Cl. F21S 4/15; F21V 23/06; F21V 21/08

(52) U.S. Cl. CPC F21S 4/15; F21Y 2115/10; F21V 21/0816; F21V 23/06

(57) ABSTRACT

A lighting device is described, which can be wrapped or attached securely around a trunk or branch of a tree or around a column, beam, pole, an arch, or other object around which the lighting device can be attached. The device includes a light apparatus having a string of lights arranged into a mesh of lights or a preformed mesh of lights, a first cord connected across a top end of the light apparatus and having a hook on each end, and at least a second cord connected across a bottom end of the light apparatus and also having a hook on each end.

### FIELD OF THE INVENTION

The invention relates to a lighting device. More particularly, the invention relates to a lighting device that can be wrapped or attached securely around a trunk or branch of a tree or around a column, beam, pole, or other generally linear object.

### BACKGROUND

The decoration or ornamentation of tree trunks with Christmas lights and other lighting devices has been accomplished using strings of lights that are wrapped around a tree trunk and connected by nails, tacks, or other securing mechanisms. Securing the lights around trees has been difficult, time consuming, and inefficient.

A need exists for a quick and efficient device and method for decorating a trunk of a tree or other generally linear object with Christmas lights or other decorative lights.

### SUMMARY

The invention relates to a wrapping light device that includes a decorative light apparatus, a first cord, and at least a second cord. One or both of the first cord and the second cord can be elastic. The decorative wrapping light device (also referred to elsewhere herein as a lighting device) can be secured around a trunk or branch of a tree, a column, a post, a beam, a pole, or any other generally linear object. The decorative light apparatus includes a string of lights arranged into a mesh of lights or a preformed mesh of lights. The decorative light apparatus can include a plurality of lights, a first end having a male electrical plug for connecting to a power source, and a second end having a female electrical socket. The decorative light apparatus also includes a top end and a bottom end and two sides. The first elastic cord is connected across the top end of the decorative light apparatus. The first elastic cord includes a first end having a first hook and a second end having a second hook that is connectable to the first hook to secure the top end of the decorative light apparatus around a tree trunk or column. The at least a second elastic cord is connected across the bottom end of the decorative light apparatus. The second elastic cord includes a first end having a first hook and a second end having a second hook that is connectable to the first hook to secure the bottom end of the decorative light apparatus around the tree trunk or column.

The invention can feature two or more decorative light apparatuses connected together electrically using their respective male electrical plugs and female electric sockets so that a portion of the tree trunk (or branch) or column can be decorated with lights.

The lighting device and methods described herein provide an advantage over conventional lighting devices and methods in that a tree trunk or other generally linear object may be decorated quickly in an aesthetically pleasing manner partially or about entirely using one or more lighting devices each of which includes a mesh of lights that can be electrically connected to one another and to a power source.

Accordingly, the invention relates to a wrapping light device that includes a light apparatus, a first cord, and at least a second cord. The light apparatus includes at least two strings of light-emitting elements and a first end having a male electrical plug for connecting to a power source. The light apparatus includes a top end and a bottom end. The first cord connects across the top end of the light apparatus. The first cord includes a first end having a first hook and a second end having an engagement apparatus that is connectable to the first hook to secure the top end of the light apparatus around an object. The at least second cord connects across the bottom end of the light apparatus. The second cord includes a first end having a first hook and an engagement apparatus that is connectable to the first hook to secure the bottom end of the light apparatus around the object.

In another aspect, the invention features the object being or including a generally linear object.

In another aspect, the invention features the object being or including a tree trunk, a tree branch, a shrub or bush, a column, a beam, a pole, an arch, or any other object around which the device is attachable.

In another aspect, the invention features the device further including a second end having a female electrical socket.

In another aspect, the invention features two or more light apparatuses being connectable together electrically using their respective male electrical plugs and female electric sockets so that the two or more lighting apparatuses are attached around at least a portion of the object.

In another aspect, the invention features the light-emitting elements being or including light-emitting diodes (LEDs).

In another aspect, the invention features the engagement apparatus that is connectable to the first hook of the first cord being or including a loop of the first cord.

In another aspect, the invention features the engagement apparatus that is connectable to the first hook of the first cord being or including a second hook of the first cord.

In another aspect, the invention features the first hook and the second hook being corrosion-resistant.

In another aspect, the invention features the engagement apparatus that is connectable to the first hook of the second cord being or including a loop of the second cord.

In another aspect, the invention features the engagement apparatus that is connectable to the first hook of the second cord being or including a second hook of the second cord.

In another aspect, the invention features the first hook and the second hook being corrosion-resistant.

The invention also features a wrapping light device that includes a light apparatus, a first cord, and at least a second cord. The light apparatus includes at least two strings of light-emitting elements, a first end having a male electrical plug for connecting to a power source, and a second end having a female electrical socket. The light apparatus includes a top end and a bottom end. The first cord connects across the top end of the light apparatus. The first cord includes a first end having a first hook and a second end having an engagement apparatus that is connectable to the first hook to secure the top end of the light apparatus around an object. The at least a second cord connects across the bottom end of the light apparatus. The second cord includes a first end having a first hook and an engagement apparatus that is connectable to the first hook to secure the bottom end of the light apparatus around the object.

In another aspect, the invention features the object being or including a generally linear object.

In another aspect, the invention features the object being or including a tree trunk, a tree branch, a shrub or bush, a column, a beam, a pole, an arch, or any other object around which the device is attachable.

In another aspect, the invention features two or more light apparatuses being connectable together electrically using their respective male electrical plugs and female electric sockets so that the two or more lighting apparatuses are attached around at least a portion of the object.

In another aspect, the invention features the plurality of light-emitting elements being or including light-emitting diodes (LEDs).

In another aspect, the invention features the engagement apparatus that is connectable to the first hook of the first cord being or including a loop or a second hook of the first cord.

In another aspect, the invention features the engagement apparatus that is connectable to the first hook of the second cord being or including a loop or a second hook of the second cord.

The invention also relates to a mesh lighting source that includes a first set of at least two strings of light-emitting elements, a second set of at least two strings of light-emitting elements. The first set of at least two strings of light-emitting elements are oriented in a first direction relative to a male electrical plug that is connectable to a power source, and the second set of at least two strings of light-emitting elements are oriented in a second direction relative to the first set of at least two strings of light-emitting elements. The foregoing first and second sets of light strings form a mesh having a top end and a bottom end. The at least one cord includes a first engagement apparatus and a second engagement apparatus. The first and second engagement apparatuses are connectable to secure the mesh to an object.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a top plan view of one embodiment of a lighting device.

FIG. 2 is a photograph of the lighting device secured around a trunk of a tree.

FIG. 3 is a photograph of a first end of a first elastic cord of a top end of the lighting device connected to a second end of the first elastic cord of the lighting device.

FIG. 4 is a photograph of the lighting device secured around a trunk of a tree.

FIG. 5 is a photograph of the lighting device secured around a trunk of a tree.

FIG. 6 is a photograph of an at least second elastic cord of a bottom end of the lighting device secured around the trunk of the tree with the lighting device being electrically connected to a power source.

FIG. 7 is a photograph of a first end of the at least second elastic cord of the bottom end of the lighting device connected to a second end of the at least second elastic cord of the lighting device.

FIG. 8 is a photograph of the lighting device secured around the trunk of the tree and connected to the power source.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

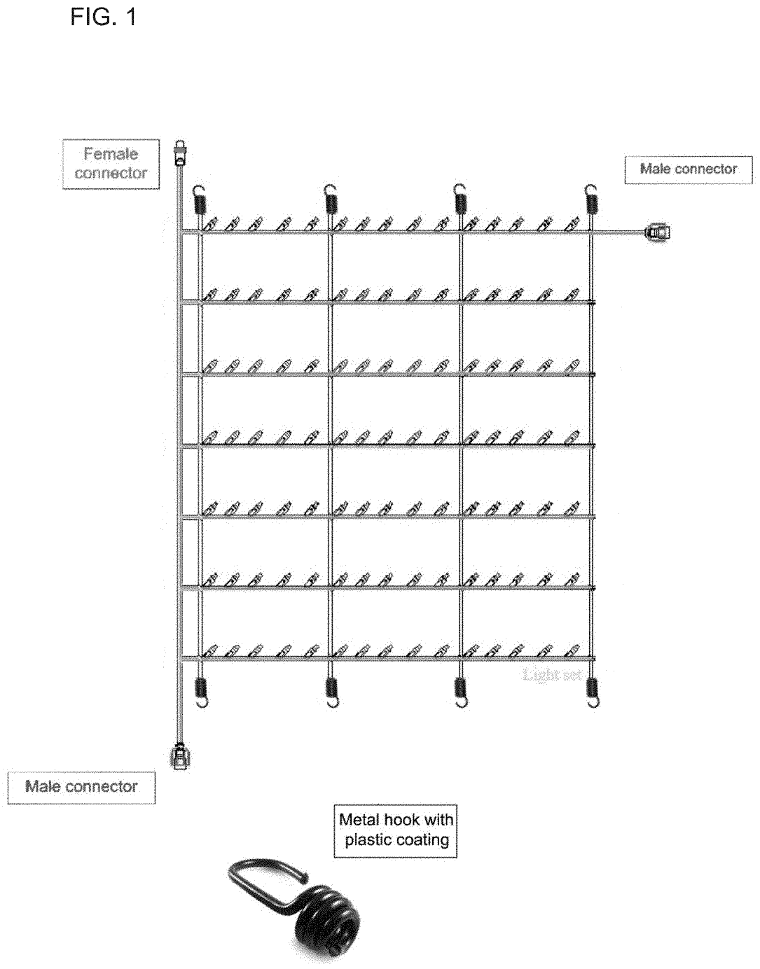

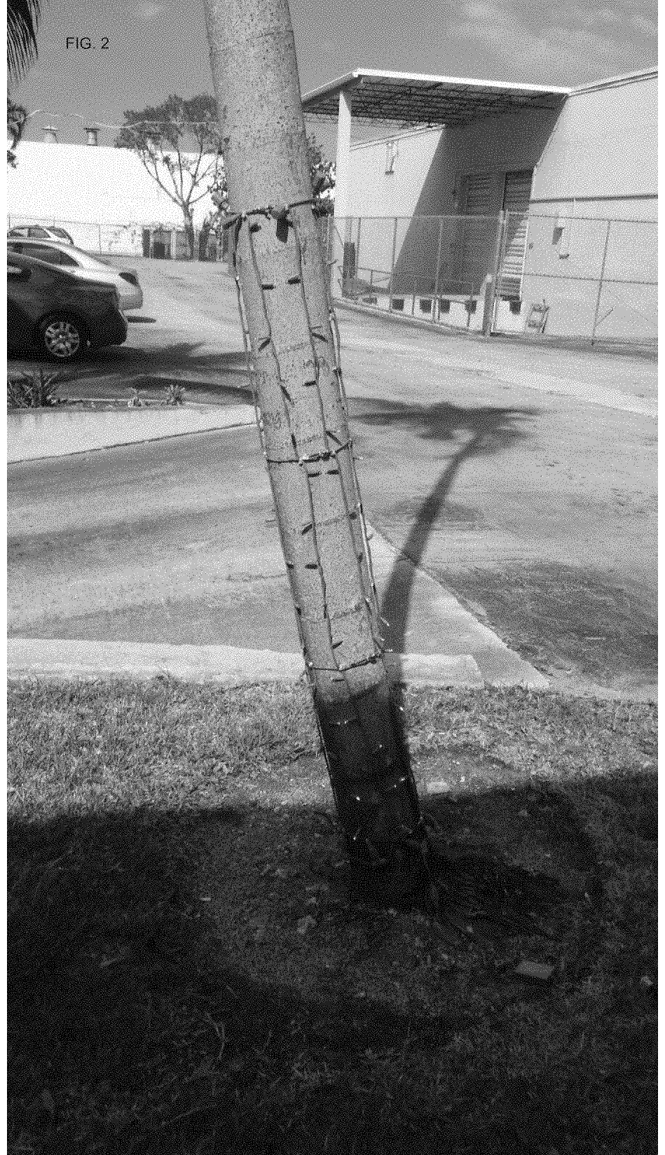

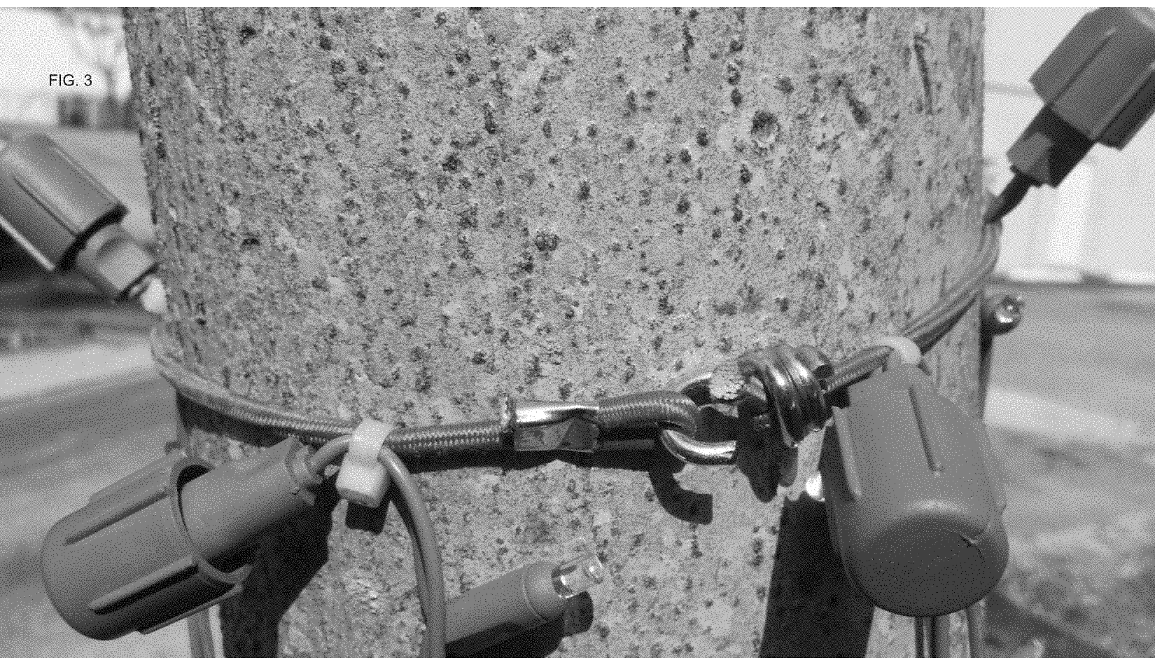

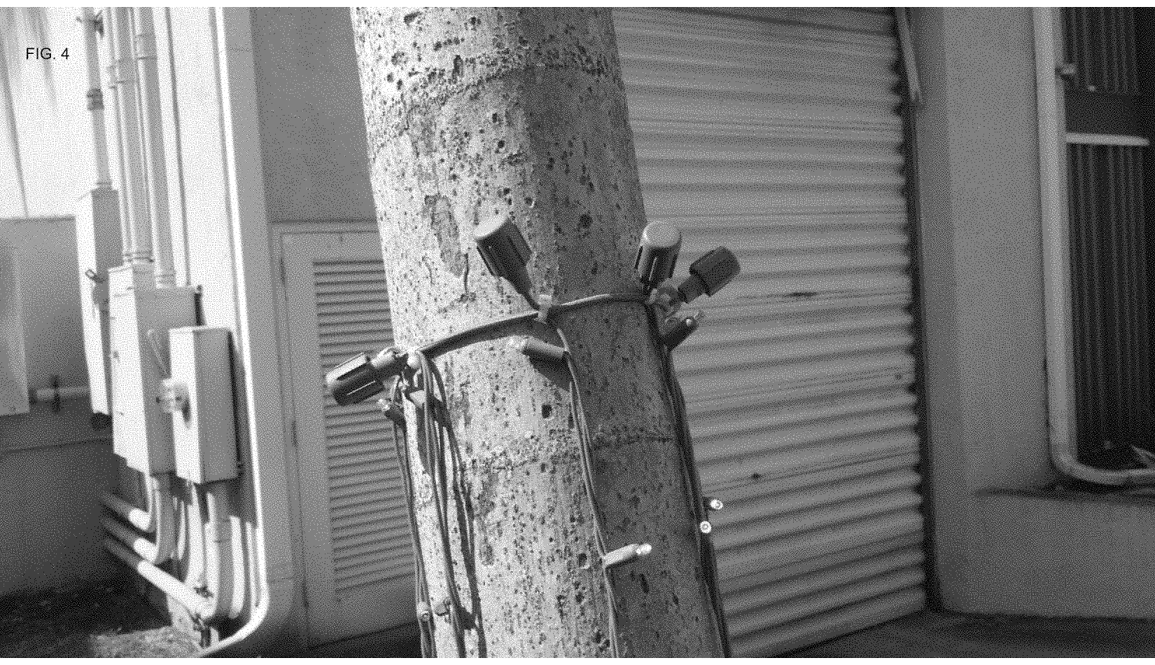

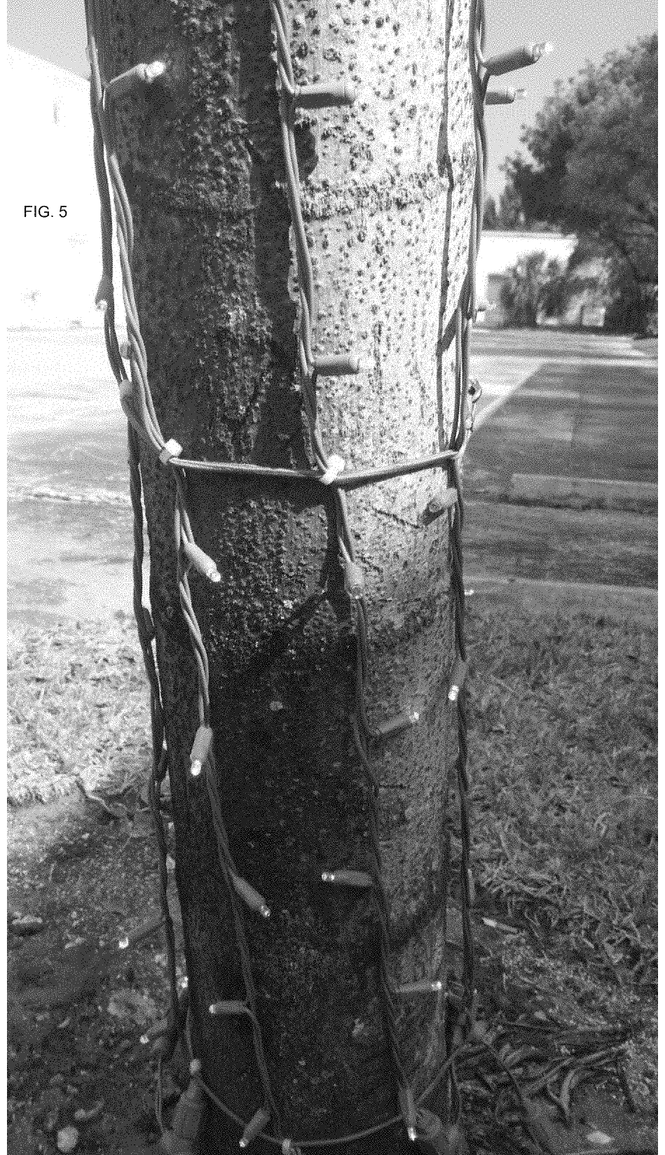

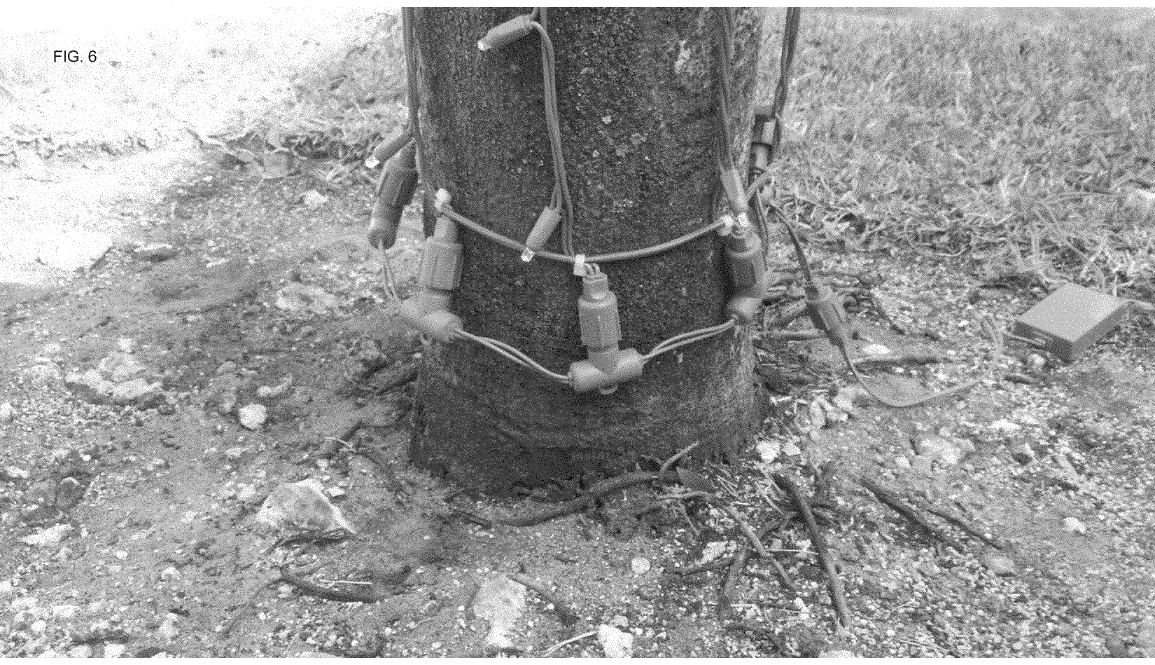

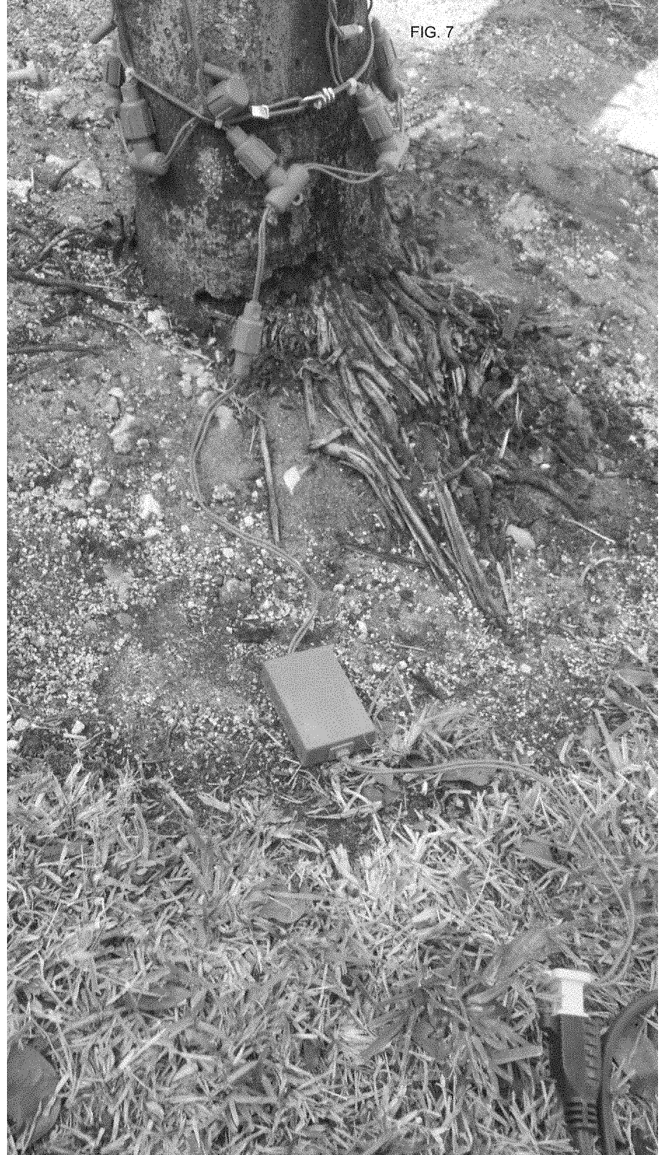

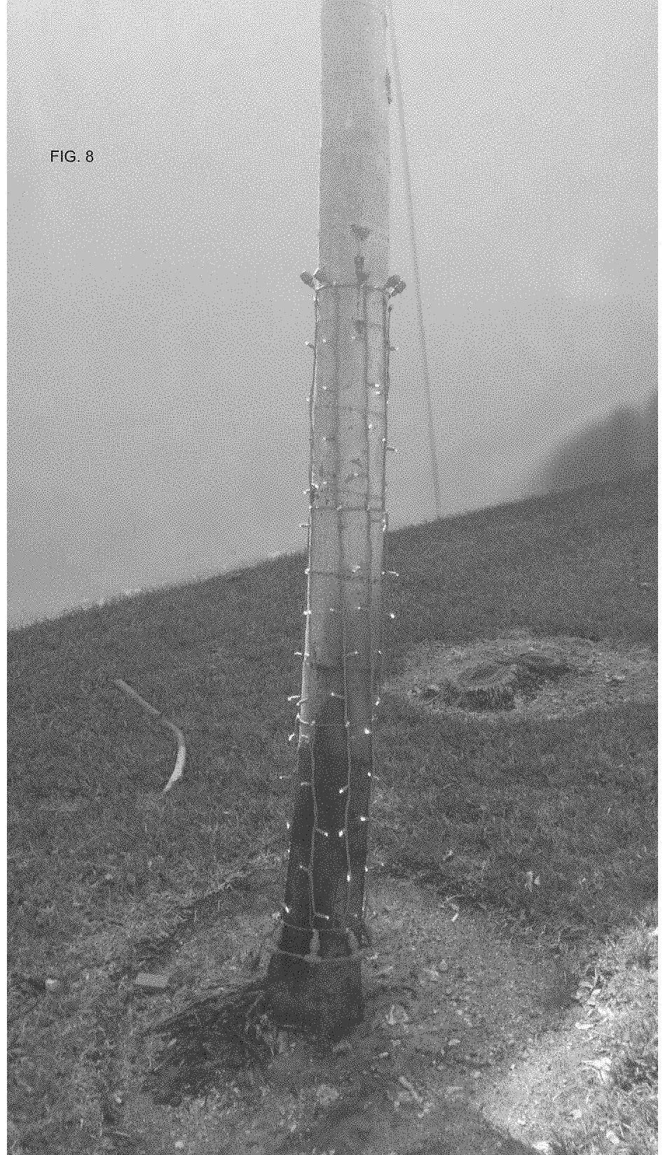

The invention provides a device for wrapping a plurality of lights around a trunk or branch of a tree or a column. The device can be a decorative lighting device and the plurality of lights can be decorative lights, e.g., for use as holiday decorations. As shown in FIGS. 1-8, the device includes a string of lights formed into a mesh. Lights preformed into a mesh may also be used with this device, although for convenience herein, the device is described with reference to a string of lights. The lights may be arranged in rows, other geometrical arrangements, or in random patterns on the mesh. The string of lights can be LED lights, incandescent lights, or other types of lights that are of the type normally used for Christmas and holiday light strings. The device can be installed around the tree trunk or column as a lighted decoration at Christmas or another holiday or for decorative purposes unrelated to any holiday. The mesh can be created in various sizes for fitting tree trunks or other linear or non-linear objects of various sizes. In another embodiment, multiple lighting devices may be connected together electrically before or after securing them around a tree trunk or other linear or non-linear object that is too large to be covered by only one such lighting device. In some embodiments, the device can be attached around an object that is not generally linear, e.g., around an arch. The object around which the device is attached can be generally cylindrical or another shape in cross-section, e.g., square, rectangular, triangular, polygonal, quadrilateral, oval, elliptical, or irregular.

The mesh is attached at top and bottom ends to a cord, e.g., a bungee cord. In exemplary embodiments, the cord or cords of the device can be elastic. For purposes of convenience, the cords herein are referred to as elastic cords. In some embodiments, the cords may be cords that are not elastic. The elastic cord includes a hook or other attachment device on each end that may be used to connect the two ends of the elastic cord together to secure the mesh of lights around the tree trunk or column. Installation around the tree trunk or column is accomplished by stretching the elastic cord at the top end of the device around the tree trunk or column until its two hooks can be hooked to one another. Similarly, the elastic cord at the bottom end of the device is stretched around the tree trunk or column until its two hooks also can be hooked to one another. The device may include additional elastic cords that are attached across a horizontal section of the mesh of lights, which may also be connected together using the hooks at their ends to secure the device around the tree trunk or column. In some embodiments, one end of an elastic cord of the device includes a hook and the other end of the elastic cord also includes a hook for connecting to the first hook. In other embodiments, one end of the elastic cord of the device includes a hook and the other end of the elastic cord includes a loop to which the hook can be connected. In embodiments that include hooks, the hooks may be corrosion-resistant. For example, one or more of the hooks could be metal having a plastic coating.

A first end of the string of lights forming the mesh includes a male electrical plug and a second end of the string of lights includes a female electrical socket so that a series of the devices can be connected together with the last device in the series (typically the device installed at the bottom of the tree trunk or column) being connected to a power source.

In one exemplary embodiment of the device, an electrical cord having a first end with a male electric plug and a second end includes two or more strings of light-emitting elements electrically connected to the electric cord and hanging vertically beneath the electrical cord from their points of attachment. The electrical cord is oriented in a generally horizontal orientation relative to the hanging strings of lights, which can be arranged in rows hanging vertically beneath the electrical cord. At or near the electrical cord, an elastic cord can be connected between the rows of hanging strings of light-emitting elements. In more exemplary embodiments, the device can include two or more elastic cords to allow for easy and secure attachment of the device around a generally linear object such as, for example, a tree trunk, a tree branch, a bush or shrub, a pole, a column, a beam, or any other generally linear object.

In some embodiments, the device includes only a single electrical cord having at least a male electrical plug. The electrical plug can include a female electrical socket for receiving the male electrical plug of another one of the devices so two or more the devices may be linked together electrically and spatially to decoratively wrap around a generally linear object like a tree trunk. In other embodiments, the device may include more than one electrical cord, each of which may include a male electrical plug, a female electrical socket, or both. In some embodiments, the electrical cords are positioned in the same orientation, e.g., one at a top of the device and another near the bottom in a horizontal orientation. In other embodiments, one electrical cord can be positioned in a first orientation (e.g., horizontally) relative to the strings of light-emitting elements hanging from it while one or more other electrical cords are positioned in a second orientation (e.g., vertically and parallel) relative to the strings of light-emitting elements.

The device is useful for wrapping any generally linear object with decorative lighting but is very well suited for wrapping tree trunks (e.g., a palm tree) with decorative or holiday lighting.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A wrapping light device comprising:
a light apparatus comprising at least two strings of light-emitting elements and a first end comprising a male electrical plug for connecting to a power source; wherein the light apparatus comprises a top end and a bottom end;
a first cord connected across the top end of the light apparatus, wherein the first cord comprises a first end comprising a first hook and a second end comprising an engagement apparatus that is connectable to the first hook to secure the top end of the light apparatus around an object; and
at least a second cord connected across the bottom end of the light apparatus, wherein the second cord comprises a first end comprising a first hook and an engagement apparatus that is connectable to the first hook to secure the bottom end of the light apparatus around the object.

2. The wrapping light device of claim 1, wherein the object comprises a generally linear object.

3. The wrapping light device of claim 1, wherein the object comprises a tree trunk, a tree branch, a shrub or bush, a column, a beam, a pole, an arch, or any other object around which the wrapping light device is attachable.

4. The wrapping light device of claim 1, further comprising a second end comprising a female electrical socket.

5. The wrapping light device of claim 1, wherein two or more light apparatuses are connectable together electrically using their respective male electrical plugs and female electric sockets so that the two or more lighting apparatuses are attached around at least a portion of the object.

6. The lighting device of claim 1, wherein the light-emitting elements comprise light-emitting diodes (LEDs).

7. The lighting device of claim 1, wherein the engagement apparatus that is connectable to the first hook of the first cord comprises a loop of the first cord.

8. The lighting device of claim 1, wherein the engagement apparatus that is connectable to the first hook of the first cord comprises a second hook of the first cord.

9. The lighting device of claim 8, wherein the first hook and the second hook are corrosion-resistant.

10. The lighting device of claim 1, wherein the engagement apparatus that is connectable to the first hook of the second cord comprises a loop of the second cord.

11. The lighting device of claim 1, wherein the engagement apparatus that is connectable to the first hook of the second cord comprises a second hook of the second cord.

12. The lighting device of claim 11, wherein the first hook and the second hook are corrosion-resistant.

13. A wrapping light device comprising:
a light apparatus comprising at least two strings of light-emitting elements, a first end comprising a male electrical plug for connecting to a power source, and a second end comprising a female electrical socket; wherein the light apparatus comprises a top end and a bottom end;
a first cord connected across the top end of the light apparatus, wherein the first cord comprises a first end comprising a first hook and a second end comprising an engagement apparatus that is connectable to the first hook to secure the top end of the light apparatus around an object; and
at least a second cord connected across the bottom end of the light apparatus, wherein the second cord comprises a first end comprising a first hook and an engagement apparatus that is connectable to the first hook to secure the bottom end of the light apparatus around the object.

14. The wrapping light device of claim 13, wherein the object comprises a generally linear object.

15. The wrapping light device of claim 13, wherein the object comprises a tree trunk, a tree branch, a shrub or bush, a column, a beam, a pole, an arch, or any other object around which the wrapping light device is attachable.

16. The wrapping light device of claim 1, wherein two or more light apparatuses are connectable together electrically using their respective male electrical plugs and female electric sockets so that the two or more lighting apparatuses are attached around at least a portion of the object.

17. The wrapping light device of claim 1, wherein the plurality of light-emitting elements comprises light-emitting diodes (LEDs).

18. The wrapping light device of claim 1, wherein the engagement apparatus that is connectable to the first hook of the first cord comprises a loop or a second hook of the first cord.

19. The wrapping light device of claim 1, wherein the engagement apparatus that is connectable to the first hook of the second cord comprises a loop or a second hook of the second cord.

20. A mesh lighting source comprising:
a first set of at least two strings of light-emitting elements oriented in a first direction relative to a male electrical plug that is connectable to a power source and a second set of at least two strings of light-emitting elements oriented in a second direction relative to the first set of at least two strings of light-emitting elements; wherein the foregoing form a mesh comprising a top end and a bottom end;
at least one cord comprising a first engagement apparatus and a second engagement apparatus; wherein the first and second engagement apparatuses are connectable to secure the mesh to an object.
